(19) United States
(12) Patent Application Publication
(10) Pub. No.: US 2026/0302403 A1
(43) Pub. Date: Oct. 1, 2026

(54) BATTERY HEATING USING NEUTRAL-FORMING TRANSFORMER IMBALANCE IN A HOME ENERGY SYSTEM

(71) Applicant: FORD GLOBAL TECHNOLOGIES, LLC, Dearborn, MI (US)

(72) Inventors: Haider Mhiesan, Canton, MI (US); Timothy Harris, Grosse Ile, MI (US); Kirk Pulay, Belleville, MI (US); Christopher Bernard Trombetta, Commerce Township, MI (US)

(21) Appl. No.: 19/364,133

(22) Filed: Oct. 21, 2025

Related U.S. Application Data
(60) Provisional application No. 63/739,980, filed on Dec. 30, 2024.

(51) Int. Cl. H01M 10/615; H01M 10/627; H02J 3/32; H02J 3/38; H02J 3/388; H02J 13/10; H02J 13/12; H02J 13/183; H02J 101/24; H02J 105/12

(52) U.S. Cl. CPC H01M 10/615; H01M 10/627; H02J 3/381; H02J 3/388; H02J 13/183; H02J 3/322; H02J 13/10; H02J 13/12; H02J 2101/24; H02J 2105/12

(57) ABSTRACT

A home energy system includes a standby battery, a neutral-forming transformer (NFT), and an imbalance control element operated by a controller to apply an electrical imbalance across the NFT when the battery temperature is below a temperature value. The electrical imbalance produces heat within the NFT that is thermally transferred to the standby battery.

### CROSS-REFERENCE TO RELATED APPLICATION

This application claims the benefit of U.S. provisional application Ser. No. 63/739,980, filed Dec. 30, 2024, the disclosure of which is hereby incorporated in its entirety by reference herein.

### TECHNICAL FIELD

This disclosure relates to energy management systems, and more particularly to control of electrical conditions in such systems.

### BACKGROUND

Residential energy systems may coordinate power transfer among grid connections and local backup elements.

### SUMMARY

A home energy system includes a standby battery, a neutral-forming transformer (NFT), an imbalance relay, and a controller that manages system operation based on temperature conditions. The controller adjusts the imbalance relay to control the neutral line current associated with the NFT, thereby influencing the temperature of the standby battery. When the battery temperature falls below a specified value, the controller activates the imbalance relay to increase the neutral line current and raise the temperature; when the temperature exceeds another threshold, it again operates the relay to stabilize the temperature. In some configurations, the standby battery and NFT are housed within a shared enclosure. The system may include an NFT relay that connects the transformer to the home load during off-grid operation, with the NFT relay and imbalance relay either sharing integrated switching elements or employing separate ones. The imbalance relay can be coupled to the NFT's secondary winding and may incorporate a controllable switch that establishes or removes electrical imbalance across the transformer. The controller transitions this switch between balanced and imbalanced states according to a stored temperature control routine. In certain embodiments, the imbalance relay is integrated with the NFT relay into a single module actuated by a common control signal. The system further includes temperature sensors associated with both the standby battery and the NFT.

A controller for a home energy system employs processing hardware and memory containing instructions that, when executed, cause the controller to initiate heating of a standby battery by operating a switch to apply an electrical imbalance across a neutral-forming transformer (NFT) whenever the battery temperature is below a defined cold-temperature value. The imbalance produces thermal energy within the transformer, which in turn warms the battery. When a mitigation condition is detected, the controller modifies operation of the switch to decrease heat generation. The mitigation condition may arise when the transformer temperature exceeds a set limit, when an imbalance current surpasses a defined current level, or when the battery reaches a target temperature. The controller may suspend the imbalance altogether or reduce its duty cycle to achieve controlled thermal moderation of the system.

A method of operating a home energy system involves monitoring a standby battery temperature and applying an electrical imbalance across a neutral-forming transformer (NFT) when the battery temperature is below a specified value. The imbalance produces heat within the transformer that is transferred to the battery to elevate its temperature. The imbalance is subsequently adjusted based on operating conditions associated with the transformer or the battery. Adjustment may include opening a switch to end the imbalance and suspend transformer heating, or otherwise modifying the imbalance according to transformer temperature, transformer current, or battery temperature to maintain stable thermal performance.

### BRIEF DESCRIPTION OF THE DRAWINGS

FIG. 1 is a schematic diagram of a home energy management system (HEMS) showing interconnections among a standby battery, a neutral-forming transformer (NFT), distributed energy resources, and a controller.

FIG. 2 is a circuit-level representation of a first embodiment in which an imbalance circuit is implemented using switching elements shared with an NFT relay.

FIG. 3 is a circuit-level representation of a second embodiment in which the imbalance circuit includes switching elements discrete from those of the NFT relay.

FIG. 4 is a state diagram illustrating exemplary heating and control transitions between cold-condition initiation, normal operation, and over-temperature mitigation states.

FIG. 5 is a flow diagram depicting a method of operating a home energy system to monitor conditions, initiate imbalance heating, and adjust or suspend heating based on system state.

FIG. 6 is a graph illustrating exemplary temperature and neutral current behavior of a home energy system during an imbalance heating cycle.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Residential power systems may include electrical infrastructure configured to distribute energy to a variety of loads within a dwelling. Such systems typically support both 240-volt and 120-volt operation to accommodate heating and cooling equipment, appliances, lighting, and consumer electronics. A 240-volt supply is commonly provided across two conductors designated L1 and L2, and 120-volt service is derived from a midpoint reference, or neutral, located between those conductors. In conventional grid-connected arrangements, the neutral reference is supplied by the utility through a grounded center tap of a distribution transformer.

In certain residential, mobile, or backup environments, a dedicated neutral conductor may be unavailable or may not be relied upon. This condition can arise when electrical power is sourced from a generator, a bidirectional inverter, or an electric vehicle that does not provide a grounded center tap. Similar configurations may occur in temporary, modular, or retrofit installations where full utility infrastructure is not provided. The absence of a neutral reference can restrict the ability to operate 120-volt loads, which typically require a balanced voltage midpoint between the L1 and L2 conductors.

To support 120-volt operation in systems without a supplied neutral, a neutral-forming transformer (NFT) may be utilized. The NFT includes windings arranged to develop a reference potential between the L1 and L2 conductors, thereby establishing a local neutral for connected loads. This arrangement allows mixed 120-volt and 240-volt operation using the same pair of supply conductors. The NFT may be located within or near a controller enclosure that also houses monitoring and control circuitry. In some implementations, the NFT operates in coordination with a supervisory controller that monitors transformer conditions and adjusts load distribution in response to operating states.

The residential energy system may further include distributed energy resources (DERs) such as photovoltaic arrays, stationary storage batteries, combustion-driven generators, or electric vehicles configured for bidirectional power transfer. These elements may operate singly or in combination to supplement or replace grid-supplied power. A supervisory control arrangement, referred to herein as a home energy management system (HEMS), may coordinate the interaction among these components.

The HEMS may include electrical and communication interfaces that manage energy flow between the grid, DERs, and local loads. It may monitor grid availability, synchronize inverter operation, and sequence transitions between grid-connected and isolated states. In various modes, the HEMS controller may engage or disengage sources, manage load connections, and maintain compatibility among devices that share the system power bus.

Within the HEMS, the NFT functions as an interface element that maintains a local neutral reference when operating in off-grid or backup conditions. The NFT may remain electrically coupled to one or more sources, such as a generator or inverter, and may be monitored for current, voltage, and temperature. The NFT may also be positioned proximate to a standby or “dark-start” battery located within the controller enclosure, such that thermal energy generated by the NFT may be incident upon the battery.

The HEMS controller may receive inputs from various sensors distributed within the system. These may include temperature sensors positioned in thermal communication with the NFT and with the standby battery, a current sensor configured to measure neutral or imbalance current between L1 and L2, and voltage sensors to track system potential. The controller may process these inputs to evaluate electrical and thermal conditions and determine whether operational thresholds are reached.

During grid-connected operation, the utility supply generally provides the primary voltage reference and power source for the residence. In this state, the HEMS may allow DERs to contribute energy in parallel with the grid or maintain them in standby depending on configuration. For example, a photovoltaic inverter may export power while grid voltage is present, whereas a generator may remain inactive until a grid outage is detected.

When the grid becomes unavailable, the HEMS may isolate the residence from the external supply, establish an internal voltage and frequency reference, and enable grid-forming DERs that can sustain local operation. During the transition, a standby battery may provide interim power to support low-voltage circuits, energize relays, and maintain communication pathways between the controller and DERs. In many systems, this standby battery must operate even before other energy sources are active.

Cold-temperature conditions can limit the effectiveness of the standby battery by reducing available capacity and inhibiting charge and discharge capability. Some approaches may include supplemental resistive heating elements that draw energy from the same limited reserve. To reduce such consumption, the present configuration utilizes the inherent heat generated by the NFT during controlled electrical imbalance as a local heat source for the nearby standby battery. The HEMS controller selectively introduces and manages this imbalance to elevate NFT temperature and transfer heat toward the battery when cold conditions are detected.

The NFT may include separate switching elements associated with the L1 and L2 conductors and at least one auxiliary switch arranged to alter current sharing between those conductors. In one implementation, Switch 1 (S1) is connected in series with L1, Switch 2 (S2) is connected in series with L2, and Switch 3 (S3) provides an alternate current path that selectively increases loading on one conductor. The switching network may be realized using discrete relays or may be integrated with the NFT assembly. When commanded by the controller, opening and closing these switches changes the relative current between L1 and L2, thereby controlling the level of electrical imbalance and associated NFT heat generation.

The HEMS controller monitors transformer temperature, battery temperature, and neutral current, and dynamically adjusts switch states in response to these conditions. When the battery temperature falls below a predetermined threshold, the controller initiates an imbalance mode by closing or opening selected switches. As the NFT warms and the battery temperature rises, the controller gradually restores balance or reduces loading asymmetry to maintain stable operation. This process may be repeated as needed to sustain the standby battery within a target temperature range.

The controller may further implement a sequence of operating states that govern transition between heating and normal modes. Example states include (1) cold-weather detection and heating initiation, (2) active imbalance heating, (3) sufficient-heat normal operation, (4) excess-heat reduction, and (5) high-temperature mitigation through deactivation of non-essential loads. The controller may transition among these states automatically based on sensor feedback and internal timers.

In addition to reactive control, the HEMS controller may incorporate predictive logic to anticipate upcoming demand or environmental changes. Weather forecast data may be used to predict low-temperature events and preemptively raise NFT temperature before the battery cools below a functional range. Machine-learning algorithms or adaptive rules may analyze prior heating cycles to refine timing and imbalance magnitude for improved energy efficiency.

The controller may also coordinate the NFT heating routine with other HEMS functions, ensuring that DER control, relay activation, and communication tasks remain available during heating operation. Priority logic may allocate available standby energy to essential control functions before applying imbalance heating to the NFT.

A user interface, such as a mobile application or web-connected control panel, may be configured to report system status and accept optional manual input. Through such an interface, a user may view transformer temperature, battery temperature, and heating status, or override automatic operation when desired. However, the imbalance-based heating and system coordination processes are primarily automated within the HEMS controller.

The described architecture positions the NFT and standby battery within a shared controller enclosure, with the NFT located close enough to promote conductive and convective heat transfer. While the illustrated embodiment shows the NFT below the battery, other relative placements may be used. Sensors and wiring may be routed within the enclosure to support monitoring, feedback, and power distribution.

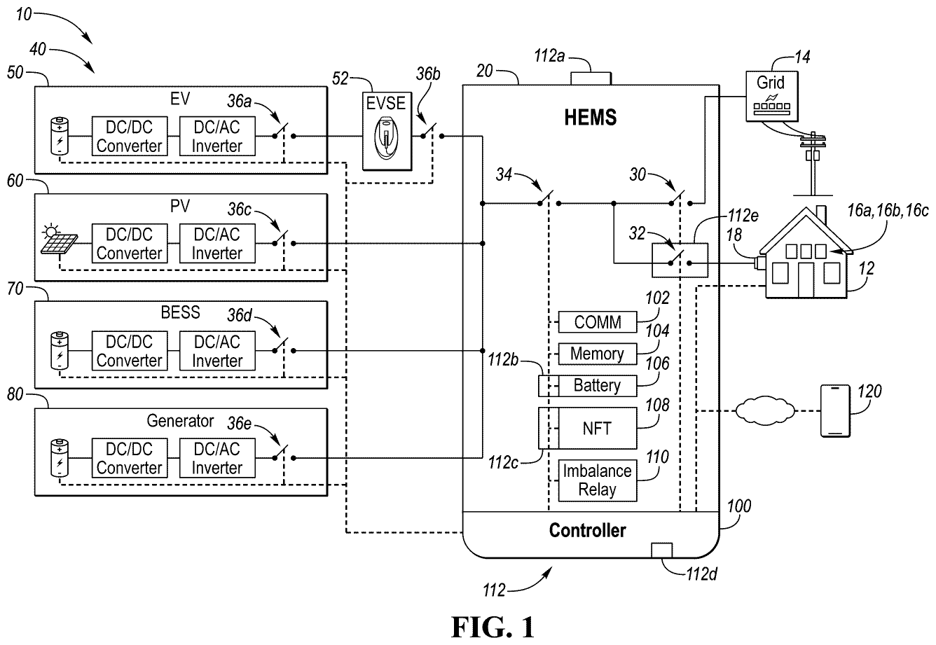

FIG. 1 illustrates one representative configuration of this home energy management system, showing the grid connection, distributed sources, switching network, NFT, and standby battery located within the controller enclosure, together with the associated sensing and control elements.

More particularly, FIG. 1 illustrates an example home energy system 10 configured to manage power distribution across various sources and loads. The system 10 includes a home 12 coupled to an electric power grid 14, as well as multiple distributed energy resources (DERs) 40 connected via a home energy management system (HEMS) 20. Power may be delivered to home loads 16a, 16b, and 16c from the grid 14, from one or more DERs 40, or in some cases from both concurrently. Power flow coordination, source prioritization, and selective isolation or activation of components may be governed by control logic within the HEMS 20.

Grid 14 is coupled to the HEMS 20 through a grid-side switch 30. Similarly, home loads 16a-16c are coupled to HEMS 20 through a load-side switch 32. These switches allow for system-level transition between grid-connected and grid-disconnected modes, and may further support full or partial isolation of the home 12 or downstream components. One or more additional load-side switches may be included to facilitate selective control over individual loads or load groups.

The grid-side switch 30 may be a main breaker that serves as a primary disconnect device, permitting selective isolation of the home 12 from the grid 14. When closed, the grid-side switch 30 allows grid-supplied power to flow to loads, DERs, or storage elements within the system. During a grid outage or selected periods of off-grid operation, the grid-side switch 30 may be opened to facilitate disconnection from the grid 14, such as to prevent backfeed or enable islanded functionality.

The load-side switch 32 may be configured to control the connection between the HEMS 20 and the loads 16a-16c of the home 12. When closed, the load-side switch 32 permits energy flow from the grid 14 or from one or more DERs 40 to the loads 16a-16c. In certain scenarios, such as load prioritization or grid-disconnected operation, the load-side switch 32 may be opened to selectively shed one or more loads or to reallocate available energy. In some embodiments, the load-side switch 32 may include multiple independently controllable relays, enabling granular control of different load segments within the home 12.

The system 10 further includes a home bus 18 that serves as an electrical distribution node interconnecting the HEMS 20 with downstream components of the home 12. The home bus 18 represents the conductive pathway by which power received from the grid 14 or one or more DERs 40 is delivered to the home 12. Loads 16a-16c, as well as other devices or subsystems that may act as sinks or sources of electrical energy, may be coupled to the home bus 18. In various embodiments, the home bus 18 may include parallel conductors for L1, L2, and neutral, or may encompass alternative wiring arrangements suitable for local electrical standards.

The DER interface 34 facilitates electrical and logical coupling between the HEMS 20 and the distributed energy resources 40. In some embodiments, the DER interface 34 may be implemented as a shared bus, physical interconnect, or power distribution panel that allows the HEMS 20 to route power to and from individual DERs. The DER interface 34 may also support monitoring and coordination functions, including relay control, inverter interaction, and data exchange via associated communication links. Each DER 40 may be coupled to the DER interface 34 through a respective switch 36a-36e, permitting the HEMS 20 to selectively connect, disconnect, or manage power flow to or from specific DERs. The DER interface 34 also permits the controller 100 to coordinate inverter timing and source sequencing.

The HEMS 20 acts as a central node for routing and coordinating energy between the grid 14, the home 12, and the connected DERs 40. The DERs 40 may include a variety of power-producing or power-storing components, each selectively coupled to the HEMS 20 through the DER interface 34.

In the illustrated embodiment, the DERs 40 include an electric vehicle (EV) 50 connected through electric vehicle supply equipment (EVSE) 52, a photovoltaic (PV) system 60, a battery energy storage system (BESS) 70, and a generator 80. Each DER 40 is electrically coupled to the DER interface 34 and includes a respective switch 36a-36e for connection control.

Switches 36a-36e correspond to the electric vehicle 50, the EVSE 52, the PV system 60, the BESS 70, and the generator 80, respectively. While each of these DERs is connected via the common DER interface 34, the system architecture allows for each DER to be monitored and actuated individually. In some embodiments, the HEMS 20 may selectively operate one or more of these switches based on real-time status, preconfigured logic, or DER-based commands.

The EV 50 and EVSE 52 collectively support bidirectional power flow and dynamic coordination with the HEMS 20. The EV 50 includes an onboard energy storage system and may operate in either a grid-following or grid-forming mode depending on system conditions. The EVSE 52 facilitates charging and discharging operations and may include conversion stages, communication links, and interlocks.

In addition to an EV 50, the home energy system 10 may incorporate additional DERs 40 to provide diverse energy inputs and storage capacity. These DERs 40 may include the PV system 60, BESS 70, and generator 80, each selectively coupled to the DER interface 34 through respective switches 36c, 36d, and 36e. These resources may operate concurrently or independently depending on system status, control priorities, and the availability of grid power, as discussed herein.

The PV system 60 operates as a renewable energy source that generates DC power from sunlight via the solar array. The generated DC power is routed through a DC/DC converter, which optimizes the voltage for feeding into the system, before it is converted to AC power by the DC/AC inverter. This AC power is then supplied to the home 12, contributing to the system's overall energy needs. The PV system's operation is integrated with the HEMS 20, which facilitates coordination with other DERs 40 and external grid conditions. During grid-connected operation, the PV system 60 works in sync with grid power to meet the load demands of the home 12, while surplus energy may be fed back to the grid 14 or used to charge the EV 50 or BESS 70.

In the event of a grid outage, the PV system 60 can continue to generate energy, but its ability to interact with the rest of the system 10 depends on the presence of a stable voltage and frequency reference, which may be supplied by a grid-forming inverter. In such cases, the inverter within the PV system 60 adjusts its output to synchronize with the grid-forming reference, enabling continued energy supply. The coordination of PV power with energy storage (via the BESS 70) and the EV 50 provides efficient energy flow and prioritized usage across the various components.

The BESS 70 stores energy for later use, helping to balance power supply and demand across the home energy system 10. The energy stored in the BESS 70 can be charged using power from the grid 14, the EV 50, the PV system 60, or the generator 80. When energy is required, the BESS 70 discharges stored energy through its associated DC/DC converter and DC/AC inverter, making it available for use by home loads 16a-16c or other system components. The BESS 70 is integrated with HEMS 20, which continuously monitors the SOC of the BESS 70.

During grid-connected operation, the BESS 70 works to reduce reliance on the utility grid 14 by managing stored energy for household use and reducing peak demand. In islanded operation, such as during a grid outage, the BESS 70 provides power to the home 12, working in conjunction with the grid-forming inverter to maintain system stability. The BESS 70 also facilitates power-sharing with the EV 50 and PV 60 as needed, either by storing excess energy produced by PV 60 during daylight hours or by discharging stored power to recharge the EV's traction battery 150.

The generator 80 serves as a backup power source for the home 12, providing continued operation when grid power is unavailable. In typical usage, the generator 80 provides AC power to the system 10 during a grid outage, automatically activating through HEMS 20 or other system logic based on the needs of the home 12. The generator's output is managed by the HEMS 20 and/or EV 50, which may, in some scenarios, ensure that it is only used when necessary, such as during high-demand periods or when other DERs (e.g., PV 60 or BESS 70) are unable to provide sufficient power.

Like other DERs 40, the generator 80 interfaces with the HEMS 20 through its own respective switch 36e, allowing for selective connection or disconnection from the system 10 as needed. The generator 80 is used to maintain power to the home 12 in islanded operation, supplementing other energy sources when the grid 14 is down or when available renewable energy from the PV system 60 or stored energy in the BESS 70 is insufficient. It also has the capability to interact with other DERs 40, providing a stable power source when energy flow from other components is limited, thereby maintaining home functionality during extended outages.

The HEMS 20 (also referred to as a “HEMS hub 20” or “combiner box”) operates as an integration and coordination point for external and local energy resources. The HEMS 20 includes various control, sensing, and switching components configured to evaluate electrical conditions and influence system behavior across the home energy system 10. These components may be housed within a shared enclosure, which may be weatherproof, thermally managed, or internally partitioned to separate high- and low-voltage regions. The HEMS 20 includes pass-through or grommeted cable routing for accommodating L1, L2, neutral, and ground conductors, along with low-voltage wiring for battery connections, control signals, and communication lines. Internally, the HEMS 20 may incorporate terminal blocks, busbars, relays, fuses, or printed circuit boards to support interconnection and coordinated operation. In some configurations, the HEMS 20 includes voltage and frequency monitoring circuitry that observes conditions on an AC bus and provides this information to an internal controller 100 for further analysis.

The HEMS 20 includes the controller 100, which manages electrical coordination across the system 10. The controller 100 may initiate control responses based on monitored conditions and predetermined logic, and may influence relays, loads, transformer connectivity, DER engagement, or interactions with the grid 14. The controller 100 includes processing hardware and memory and may be configured to execute software or firmware routines that enable real-time monitoring, threshold comparison, and operational sequencing. In some configurations, the controller 100 may respond autonomously to internal events, while in other cases, it may interact with remote systems or external user inputs to support coordination.

Although the controller 100 is illustrated as integrated within the HEMS 20, in alternative embodiments, the controller 100 may reside elsewhere within the home 12 or may be partially or entirely remote. In such cases, local sensors or actuators may report to a cloud-based platform, which may in turn transmit control commands back to the system 10. The controller 100 may therefore operate as part of a centralized, distributed, or hybrid control architecture, depending on the implementation.

The controller 100 is operatively connected to a communication interface 102, which facilitates bidirectional data exchange with other system components as well as with external systems such as the remote device 120. The communication interface 102 may support one or more wired or wireless protocols (e.g., Ethernet, Wi-Fi, Bluetooth, or cellular) and may be used to retrieve updated control logic, firmware patches, or configuration profiles from remote sources. The interface 102 may also allow monitored system parameters or operating states to be reported to external entities, such as utility operators, cloud dashboards, or mobile applications.

The remote device 120 may be a mobile phone, tablet, computer, home assistant, or dedicated user interface that facilitates interaction with the HEMS 20. In some implementations, the remote device 120 may display status information, receive push alerts, or provide options for the user to view, adjust, or override HEMS settings. The remote device 120 may access the system 10 through a cloud-based platform or through a local network connection. In certain implementations, the remote device 120 may also receive DER SOC data, forecasted solar production, or pending grid event notifications. These interactions may enable users to schedule charging, prioritize critical loads, or configure fallback settings for islanded operation.

The controller 100 includes or is associated with a memory 104 that stores logic routines, control thresholds, action tables, and condition mappings. The memory 104 may be embedded within the controller 100 or may be located remotely and accessed through the communication interface 102. In some cases, the memory 104 may be updated over time to reflect changing usage profiles, system expansions, or firmware revisions. When executed, the stored instructions cause the controller 100 to perform energy management functions including (but not limited to) relay operation, DER engagement, transformer switching, and condition-based coordination across the system 10.

To support local AC energization during grid outages, the HEMS 20 may include a reserve energy source, which may be referred to as a standby battery 106 or dark start battery. The standby battery 106 provides DC power to energize control circuits or initiate inverter startup when grid voltage is absent. Under normal conditions, the standby battery 106 may remain isolated and only become active during startup routines or after a grid outage has been detected. In addition to supporting controller 100 and communication interface 102, the standby battery 106 may be coupled to a heating element configured to elevate or maintain the battery's operating temperature in cold environments. The presence of the heating element allows the standby battery 106 to deliver consistent startup power under a range of environmental conditions.

The HEMS 20 may include inverter as part of, or separate but coupled to, the standby battery 106. The inverter may be configured as a grid-forming inverter that supplies an AC voltage and frequency reference onto the system bus, which can be used to initiate or sustain local power delivery. When energized, the inverter may provide the basis for reconnecting grid-following DERs such as the PV system 60 or BESS 70. In this manner, the inverter enables system startup, load support, or DER coordination during periods when grid power is unavailable.

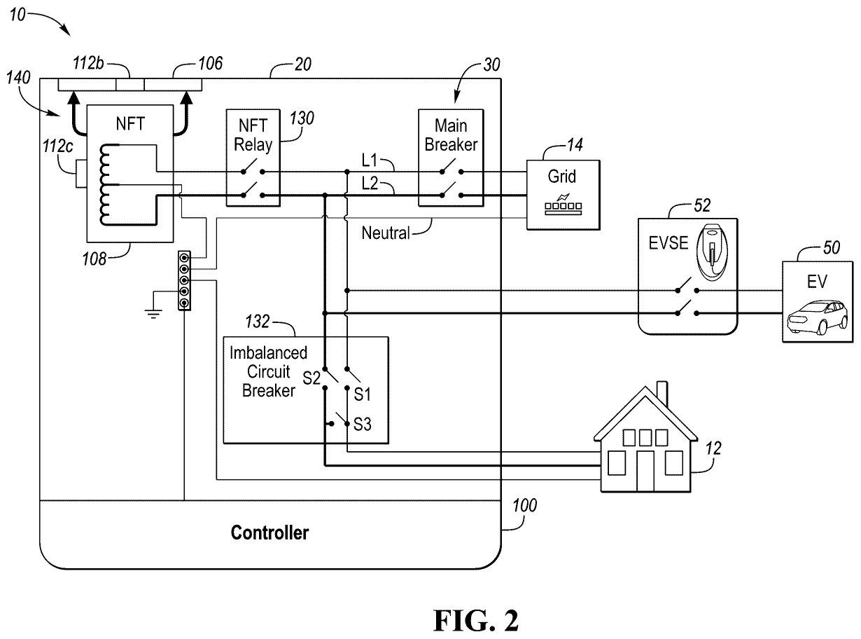

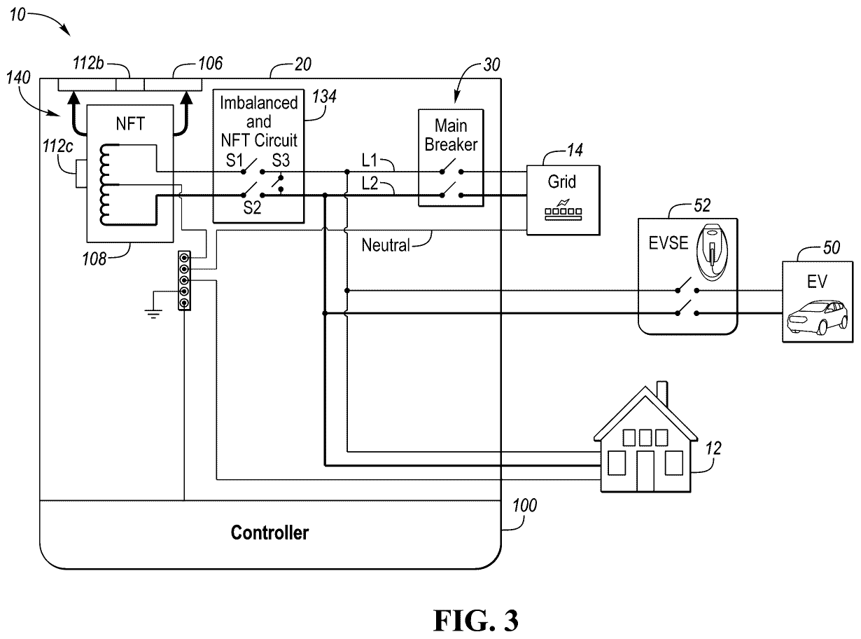

The HEMS 20 further includes the NFT 108, which facilitates 120V operation during off-grid scenarios. The NFT 108 may comprise a center-tapped winding or other structure capable of producing a synthetic neutral reference between L1 and L2. This supports the continued operation of loads that require a neutral connection in the absence of utility service. The NFT 108 may be selectively engaged or disengaged using a relay associated with the transformer. The controller 100 may monitor grid presence, voltage levels, or transformer temperature and activate or isolate the NFT 108 accordingly. As will be discussed with reference to FIGS. 2 and 3, the NFT 108 may also participate in controlled imbalance routines managed by the controller 100.

The HEMS 20 further includes an imbalance relay 110 configured to manage the electrical relationship between conductors coupled to the NFT 108. In some configurations, the imbalance relay 110 may be selectively operated to modify current flow between the L1 and L2 lines, thereby adjusting the degree of electrical symmetry within the NFT circuit. The relay 110 may be implemented as a contactor, switch assembly, or equivalent device capable of establishing or interrupting conductive paths under control of the controller 100. In normal operation, the relay 110 may remain in a balanced state; during specific control sequences, it may transition to an imbalanced state to influence transformer loading or temperature, as described below with respect to FIGS. 2 and 3.

The HEMS 20 further includes one or more sensors 112 operatively coupled to the controller 100. The sensors 112 provide environmental and electrical data used to evaluate system conditions and to support closed-loop control of NFT and standby battery operation. The sensor set may include temperature, voltage, and current sensors located at various positions within the HEMS hub 20 and across associated conductors.

An ambient sensor 112a may be positioned within or adjacent to the HEMS enclosure 20 to detect local air temperature surrounding the NFT 108 and standby battery 106. A battery sensor 112b may be thermally coupled to the standby battery 106 to measure battery temperature during operation. An NFT sensor 112c may be positioned in thermal communication with the NFT 108, such as at a winding surface or on the transformer enclosure, to measure transformer temperature. A controller sensor 112d may be located near processing circuitry of the controller 100 to monitor localized heating of electronics during active operation.

Additional sensors 112e may be placed along the L1 and L2 conductors, the neutral connection, or near switching elements such as the grid-side switch 30 or DER interface 34. These sensors may provide current, voltage, or phase-angle data used by the controller 100 to evaluate loading balance and identify developing asymmetry between supply lines. In some configurations, a neutral-current sensor may be included to measure differential current through the NFT midpoint, providing a direct indication of imbalance magnitude.

Data from sensors 112a-112e are received by the controller 100, which processes the inputs using stored thresholds, tables, and routines within memory 104. The controller 100 may compare measured conditions to defined ranges and determine whether to adjust operating states, modify load connections, or initiate NFT control actions. These inputs also provide real-time feedback for the imbalance relay 110, enabling responsive management of transformer conditions.

The controller 100 may also receive information reflecting the operational state of other system components. For example, the controller may detect whether grid-side switch 30 and load-side switch 32 are open or closed, whether individual DER switches 36a-36e are engaged, and whether a grid reference is present at the grid 14. Based on this information, the controller 100 determines whether NFT-based neutral formation or imbalance heating is appropriate.

The configuration illustrated in FIG. 1 therefore represents a supervisory environment in which the controller 100, standby battery 106, and NFT 108 operate within a shared HEMS hub 20. The sensors 112a-112e provide measurement feedback to the controller 100, which coordinates energy management, monitors transformer conditions, and directs the imbalance relay 110 as part of an integrated control sequence.

Referring now to FIG. 2, an example embodiment of the home energy system 10 includes discrete switching elements arranged to control operation of the NFT 108 and to implement controlled imbalance. In this embodiment, the NFT 108 is located within the HEMS hub 20 and is positioned below the standby battery 106. The spatial arrangement facilitates transfer of thermal energy from the NFT 108 toward the standby battery 106 when the NFT is energized and producing heat. This upward heat flow is generally represented as heat 140 in the illustration.

The NFT 108 is coupled to the L1 and L2 conductors through an NFT relay 130, which serves as the primary connection and disconnection element for the transformer. The NFT relay 130 may be a contactor or switching device operated by the controller 100 to engage the NFT when a local neutral reference is required, or to isolate it during inactive periods. When the NFT relay 130 is closed, the transformer windings establish a neutral reference that divides the potential between the two lines.

A separate imbalance control relay 132 is connected across selected portions of the NFT circuit to intentionally alter current distribution between the L1 and L2 lines. In one configuration, the relay 132 introduces an auxiliary conductive path on one side of the circuit, producing a controlled asymmetry that increases transformer current and heat generation. The imbalance control relay 132 is actuated by the controller 100 in response to cold-temperature detection, battery temperature feedback, or predetermined heating routines.

During heating operation, the controller 100 monitors transformer and battery temperatures through sensors 112b and 112c, and dynamically actuates the imbalance control relay 132 to control transformer heating. When NFT temperature or battery temperature reaches defined thresholds, the controller 100 may open or modulate the relay 132 to restore current balance and maintain stable conditions. The NFT relay 130 may remain closed throughout this process, ensuring continuous neutral formation during heating operation.

In the embodiment of FIG. 2, current through the NFT 108 may be measured by the line sensors 112e, while neutral current or differential current may be monitored by a dedicated neutral-current sensor. The controller 100 evaluates these values to determine imbalance magnitude and adjust switching states accordingly. This closed-loop process enables the NFT 108 to generate sufficient heat to elevate the nearby battery 106 temperature without exceeding transformer limits.

FIG. 3 illustrates another embodiment of the home energy system 10, in which the functions of the NFT relay 130 and imbalance control relay 132 are integrated into a single combined NFT-imbalance circuit 134. The circuit 134 may include a multi-pole relay, hybrid contactor, or equivalent device capable of both engaging the NFT 108 and creating an intentional asymmetry between the L1 and L2 lines. The combined circuit 134 reduces component count and may simplify wiring and control coordination within the HEMS hub 20.

In the embodiment of FIG. 3, the controller 100 actuates the combined NFT-imbalance circuit 134 to engage the transformer and control heating behavior in the same manner as described for the discrete arrangement of FIG. 2. Heat 140 is again generated by the NFT 108 and rises toward the standby battery 106, helping to sustain the battery's operating temperature. Sensor feedback from elements 112b and 112c allows the controller 100 to govern the circuit 134 in real time to sustain desired temperature levels.

The embodiments of FIGS. 2 and 3 therefore illustrate two representative implementations of the imbalance-control concept within the home energy system 10. In each case, the controller 100 monitors thermal and electrical conditions, commands switching elements to induce or remove imbalance, and maintains the NFT 108 in a range suitable for both neutral formation and localized heating. The use of separate or integrated relays represents a design choice that may be selected based on system packaging or control preferences.

The configurations shown in FIGS. 2 and 3 may further include shielding, conductive pathways, or internal partitions that guide heat 140 toward the standby battery 106 and limit heat migration to other regions of the enclosure. The enclosure may include conductive walls or airflow passages to promote efficient thermal coupling between the NFT 108 and the battery 106 while maintaining electrical isolation between power and control components.

The arrangement of the NFT 108, standby battery 106, controller 100, and associated switching assemblies within the HEMS hub 20 provides a compact and functional module capable of both power coordination and controlled heating. The system architecture allows for direct sensing of transformer and battery temperatures, feedback-based adjustment of imbalance magnitude, and selective activation of neutral formation and heating states.

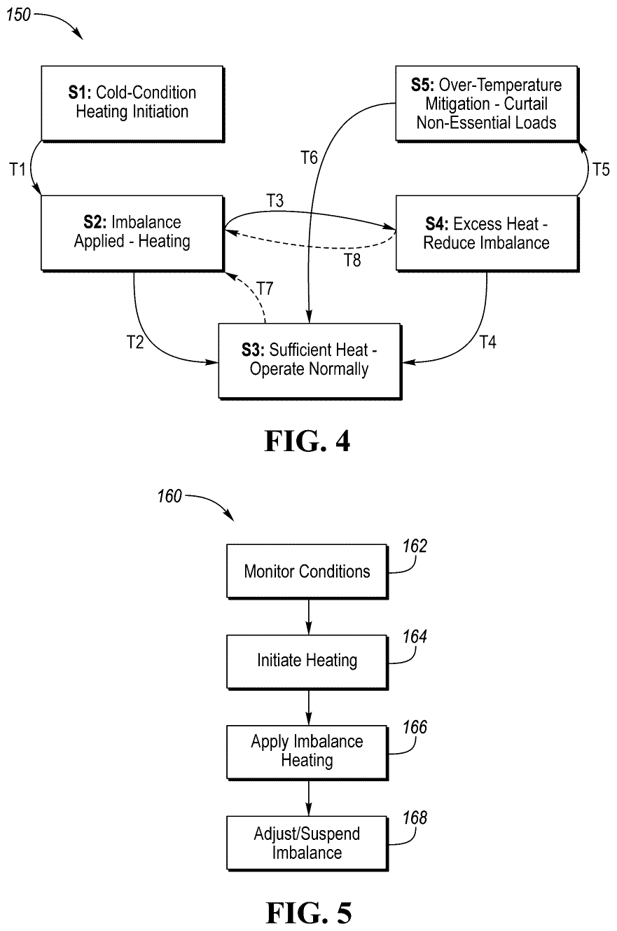

FIG. 4 illustrates an example state diagram 150 representing a control routine executed by the controller 100 of the HEMS 20. The routine governs operation of the neutral-forming transformer 108 and standby battery 106 during cold-condition startup and subsequent thermal stabilization. Each state corresponds to a distinct operational mode defined by temperature, current, or voltage conditions. The controller 100 transitions among states S1-S5 in response to signals from sensors 112b and 112c, which respectively monitor the standby-battery temperature and the transformer temperature. Transitions T1-T8 are labeled in FIG. 4 to indicate conditions under which the controller 100 modifies NFT current imbalance or adjusts load participation. Solid-line transitions represent principal control paths, and dashed-line transitions represent optional or hysteresis-based paths that may occur during steady-state or recovery operation.

State S1 represents the initial heating condition that occurs when a cold-temperature threshold is detected. The controller 100 identifies that the battery-temperature sensor 112b reports a value below a stored minimum (T_batt,min). In this state, the controller 100 prepares to generate heat by activating internal control logic that enables the imbalance relay 110 or an associated switching circuit within the HEMS 20. During this preparatory phase, the controller 100 verifies grid or DER availability, confirms system readiness, and may initiate preliminary communication with connected power sources. Transition T1 occurs when environmental and electrical prerequisites are satisfied, advancing the system to state S2 for active heating.

In state S2, the controller 100 actuates the imbalance relay 110 to apply a controlled asymmetry across the transformer 108 windings. The resulting neutral current Iₙ generates heat 140 proximate to the transformer core and adjacent components, including the standby battery 106 positioned above the NFT 108. The controller 100 continuously monitors transformer temperature (via sensor 112c) and neutral current magnitude to maintain operation within predetermined bounds. When the standby-battery temperature rises above a stored operating threshold (T_batt,ok), transition T2 directs the controller 100 to state S3. If transformer heating becomes excessive (as indicated by a rise in T_NFT above a maximum limit or an increase in Iₙ beyond a rated threshold), transition T3 advances the controller 100 to state S4 for corrective action.

State S3 corresponds to steady operation after the standby battery 106 reaches an acceptable temperature range. The controller 100 restores balanced transformer conduction by de-energizing or modulating the imbalance relay 110. During this state, normal HEMS coordination resumes, and the controller 100 continues to monitor battery and transformer temperatures to confirm stability. When temperature values remain within acceptable limits, the system maintains this state. If the battery temperature later drops below the lower hysteresis boundary, optional transition T7 returns the controller 100 to state S2 to re-establish heating. State S3 therefore provides the equilibrium phase in which the NFT 108 operates without deliberate imbalance while retaining readiness for subsequent heating cycles.

State S4 represents a corrective condition entered when excessive heating or transformer stress is detected. The controller 100 partially or fully reduces the imposed imbalance by adjusting the relay 110 or by engaging a bypass pathway that redistributes current across the NFT 108. Temperature and current values are continually assessed until both fall below the predefined limits. When cooling is verified and the battery temperature remains within range, transition T4 returns the system to state S3. If cooling is incomplete or the NFT 108 remains elevated above its allowable range, the controller 100 may continue to monitor until either a stabilization timer expires or a secondary condition triggers transition T5 to state S5. In some implementations, once cooling is complete and heating demand persists, optional transition T8 returns the controller 100 directly to state S2 to resume controlled heating.

State S5 is a mitigation mode activated when transformer temperature or current imbalance remains above defined thresholds for a sustained interval. The controller 100 interprets this condition as an over-temperature potential and temporarily curtails non-essential loads (e.g., within the HEMS 20). Load reduction may be accomplished by opening selected load-side relays 32 or by issuing curtailment signals to connected DERs 40. This state remains active until temperature data indicate that the NFT 108 has cooled and normal electrical balance can be re-established. When transformer and battery temperatures stabilize, transition T6 returns the controller 100 to state S3.

The transitions T1-T8 in FIG. 4 are governed by temperature thresholds, current limits, and timing intervals stored in the memory 104 of the controller 100. Each transition may incorporate hysteresis to prevent oscillation between adjacent states. The controller 100 may also apply time-based dwell periods to ensure that temperature trends are stable before advancing or reverting states. Optional transitions T7 and T8 correspond to hysteresis-driven return paths that maintain temperature control during extended cold conditions or after partial cooldown events. The combination of temperature, current, and temporal parameters provides a coordinated control scheme that sustains operational balance between transformer heating and standby-battery readiness.

FIG. 5 illustrates a representative method 160 for controlling imbalance heating in connection with the neutral-forming transformer (NFT) 108 of the home energy management system (HEMS) 20. The method 160 is executed by controller 100 and may be implemented through one or more hardware, firmware, or software modules. The method governs selective heating of the NFT 108 to generate localized heat 140 for elevating or maintaining the temperature of the standby battery 106. In general, the method 160 includes four primary steps: monitoring conditions (162), initiating heating (164), applying imbalance heating (166), and adjusting or suspending the imbalance (168). These steps correspond functionally to the state transitions of FIG. 4 and may be repeated as environmental and electrical conditions evolve. During execution, the controller 100 records operating data corresponding to each transition, including temperature, current, and relay state values, thereby providing a traceable operational record for detectability verification.

At step 162, the controller 100 monitors a plurality of operating parameters within the HEMS 20 using sensors 112a-112e. The monitored parameters may include the temperature of the standby battery 106 (T_batt) detected by sensor 112b, the temperature of the NFT 108 (T_NFT) detected by sensor 112c, and the magnitude of neutral current (I_N) measured by a current sensor positioned between the L1 and L2 conductors. Additional parameters such as line voltage, ambient temperature within the HEMS enclosure, and controller board temperature may also be evaluated. The controller 100 samples these parameters at periodic intervals and compares the readings with threshold values stored in memory 104. When T_batt falls below a reference threshold (T_min or T_ref−Δ), the controller determines that cold-condition heating is warranted. Prior to activating heating, the controller may also verify grid or DER availability and confirm that the NFT 108 and imbalance relay 110 are in a ready state. Each monitored event may be time-stamped and stored locally or transmitted to a remote database, establishing a traceable log of system conditions over time.

At step 164, the controller 100 initiates a heating sequence in response to a detected low-temperature condition. This may include enabling one or more switching elements configured to support controlled current imbalance through the NFT 108. The controller 100 verifies relay contact integrity, electrical continuity, and adequate voltage for heating operation. Once readiness is confirmed, the controller 100 energizes the imbalance relay 110 or, in other embodiments, the combined imbalance and NFT relay 134, establishing a current path capable of generating asymmetrical loading between the L1 and L2 conductors. The controller 100 may additionally define an initial duty cycle or current-limit profile to moderate startup heating. In certain implementations, the initiation step 164 may also be performed pre-emptively, using predictive data such as outdoor temperature forecasts or prior load patterns to begin warming before the standby battery 106 reaches the cold threshold. Completion of the initiation step is recorded together with sensor readings and relay status indicators for subsequent analysis.

At step 166, the controller 100 applies imbalance heating by intentionally creating an asymmetry in the current distribution through the NFT 108. The imbalance may be produced through a dedicated imbalance circuit 132 that forms a shunt path between one transformer half-winding and the neutral node, or through an integrated relay 134 that differentially connects the transformer windings to alter current flow. The resulting neutral current (I_N) produces resistive and magnetic losses within the transformer core, generating localized heat 140 in proximity to the standby battery 106. The controller continuously monitors T_NFT, T_batt, and I_N to maintain operation within specified limits. Heating continues until T_batt reaches a target operating temperature (T_ok) or until an overtemperature or overcurrent condition is detected (T_NFT>T_max or I_N>I_limit). Upon achieving sufficient heat, the controller may return to step 162 for continued monitoring. If excess heat or excessive current is observed, the controller advances to step 168 to reduce or suspend the imbalance. Each heating interval is logged with corresponding sensor data, allowing verification of system response and confirming that heating occurred as commanded.

At step 168, the controller 100 adjusts or suspends the imbalance to manage transformer and battery temperature within allowable ranges. Adjustment may involve scaling down the imbalance magnitude through pulse-width or duty-cycle control, de-energizing one secondary winding, or alternating between energized and de-energized states to sustain mild heating while preventing further temperature rise. Full suspension occurs when T_NFT or I_N exceed predefined limits or when fault conditions are detected in sensors or switching devices. During a suspension interval, the controller observes a cooldown delay (t_cool) until the monitored values return to within range. When the standby battery 106 remains below its operational threshold after cooldown, the controller re-enters the heating step 166 to resume controlled imbalance operation.

In some implementations, the controller 100 may execute a load-curtailment subroutine when elevated temperature persists despite suspension of the imbalance. Under this condition, the controller selectively deactivates one or more non-essential household loads (16a-16c) by operating the load-side switch 32 or individual circuit relays to disconnect discretionary devices such as lighting, receptacle, or auxiliary circuits. Essential elements—including the NFT 108, standby battery 106, communication interface 102, and control electronics-remain energized to preserve critical functionality. The curtailment event may remain active until temperature readings fall below a defined recovery threshold, after which the controller gradually re-enables the affected loads in accordance with stored load-priority profiles. Each curtailment, re-enablement, and associated temperature recovery interval is recorded with timestamped sensor data to preserve an auditable trace of system behavior.

Throughout execution of the method 160, the controller 100 may record the measured parameters, relay states, and transition events associated with each of the steps 162-168. These data are maintained within local memory 104 or transmitted via communication interface 102 to a remote device 120 or cloud-based repository. Load-shedding and restoration events may likewise be logged with corresponding transformer and battery temperatures, enabling traceable confirmation that curtailment was executed in response to thermal conditions.

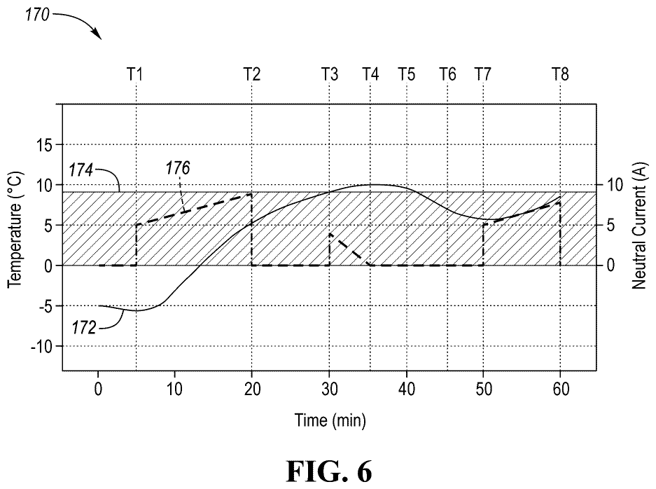

FIG. 6 illustrates one representative set of operational traces for the home energy system 10 described above, showing the relationship between battery temperature 172 and neutral current 176 over time during a cold-condition heating cycle. The depicted trace corresponds generally to the control sequence described in connection with FIGS. 4 and 5, and is representative of a scenario in which the controller 100 of the HEMS 20 initiates and manages imbalance-based heating under low-temperature startup conditions. The horizontal axis represents elapsed time in minutes, while the left vertical axis corresponds to measured temperature in degrees Celsius, and the right vertical axis corresponds to the magnitude of neutral current flowing through the NFT 108. A shaded region 174 defines a target operating temperature band that represents the range within which the standby battery 106 is maintained for reliable activation and control operation.

At time zero, the system 10 is in a cold-soaked condition following extended exposure to sub-freezing temperatures. The battery temperature 172 is below 0° C., and the controller 100 has not yet initiated any heating process. The imbalance relay 110 remains open, and the neutral current 176 is at zero. This period corresponds to the S₁ (Cold-Condition Heating Initiation) state of FIG. 4, during which ambient sensors 112a and battery sensor 112b confirm the need for heating. As shown in FIG. 5, the controller 100 continuously monitors temperature and voltage conditions (Step 162) until the temperature falls below a threshold that triggers the heating sequence. At transition T₁, the controller 100 advances from monitoring to activation and issues a command to close the imbalance relay 110, applying an electrical imbalance across the NFT 108.

Once imbalance heating begins (S₂ of FIG. 4, Step 166 of FIG. 5), the neutral current 176 rises sharply to a preset magnitude, and the NFT 108 begins generating resistive heat that transfers through the surrounding enclosure toward the standby battery 106. The battery temperature 172 responds with a gradual rise as stored thermal energy accumulates. Between transitions T₁ and T₂, the curve shows a steady positive slope, reflecting continuous heating as current is maintained. When the temperature 172 reaches the lower boundary of the target band 174 (e.g., approximately 0-5° C.), the controller 100 determines that sufficient thermal energy is present for normal operation and initiates transition T₂ to S₃ (Operate Normally).

During S₃, the imbalance relay 110 is opened, returning the neutral current 176 to zero while residual heat in the NFT 108 and enclosure continues to raise the battery temperature 172 slightly. The curve exhibits a transient overshoot beyond the midpoint of the target band 174, reaching a peak of roughly 8-10° C. This overshoot reflects the delayed thermal response inherent in passive heat transfer through metallic and structural materials of the HEMS 20. In some embodiments, as described with reference to FIG. 2, heat generated in the NFT 108 (identified as 140) propagates upward toward the battery 106, and the resulting temperature profile may vary with component spacing and enclosure geometry.

At transition T₃, corresponding to entry into S₄ (Excess Heat-Reduce Imbalance) of FIG. 4, the controller 100 detects that transformer or battery temperature has exceeded an upper threshold. To moderate heating, the controller partially re-engages the imbalance relay 110 with a reduced duty cycle or lower current setpoint, shown in FIG. 6 as a short pulse of neutral current 176. This corrective action causes the temperature 172 to level off and begin a controlled decline toward the midpoint of the target band 174. As temperature stabilizes, the controller executes transition T₄, returning to the S₃ (Operate Normally) state.

Continued monitoring under S₃ eventually reveals that transformer temperature remains elevated relative to ambient, but overall system load and thermal distribution are stable. At approximately transition T₅, representing the onset of S₅ (Over-Temperature Mitigation), the controller 100 detects that a persistent overheat condition exists despite reduced imbalance current. In response, it curtails or suspends one or more non-essential loads within the home 12, such as lower-priority DERs 40 or background electronics. This temporary curtailment corresponds to Step 168 in FIG. 5 and provides a cooling window during which the NFT 108 and battery 106 dissipate stored heat.

Following this period (T₆), thermal equilibrium is restored, and the controller 100 resumes normal operation with neutral current 176 again at zero. The battery temperature 172 declines gradually toward the lower portion of the band 174 as residual heat dissipates. Once temperature drops below the lower limit and the controller's predictive logic determines that continued cooling would compromise standby readiness, transition T₇ is executed, re-entering the S₂ (Imbalance Applied-Heating) state. Neutral current 176 is again applied, and temperature 172 rises until the target band 174 is re-entered. At this point (T₈), the controller 100 deactivates heating and returns to the S₃ (Operate Normally) state, completing one representative thermal cycle.

The transitions T₁-T₈ shown in FIG. 6 thus represent measurable control events that correlate directly with the state logic of FIG. 4 and the method steps of FIG. 5. Each transition is accompanied by observable changes in one or more monitored parameters-most notably the slope and magnitude of the battery-temperature curve 172 and the activation or cessation of neutral current 176 through the NFT 108. The correspondence of these parameters provides a diagnostic trace that can be recorded by the controller 100 or communicated via the interface 102 for verification or fault analysis.

The control logic described herein may be implemented as executable firmware instructions within the controller 100 of the HEMS 20. Threshold values, timing constants, and decision rules may be stored in memory 104 and updated through the communication interface 102, either locally or through cloud coordination with the remote device 120. In certain embodiments, the controller 100 may anticipate temperature deviation trends based on ambient sensor readings, historical data, or environmental forecasts, enabling predictive modulation of neutral current Iₙ prior to threshold crossings. These predictive routines may be derived from learned operating profiles or user-defined policies that determine when to initiate imbalance heating or reduce load demand. Through such adaptive and anticipatory control, the system 10 provides consistent and efficient heating behavior while minimizing unnecessary relay cycling or energy use.

The configurations described above therefore represent one implementation of a home energy system 10 in which environmental sensing, controller logic, and distributed energy resources 40 operate cooperatively to maintain functionality under cold temperature conditions. Although particular thresholds, time intervals, and temperature ranges have been described, these examples are illustrative rather than limiting. In other embodiments, the cold-start threshold may vary with battery chemistry, imbalance magnitude may be applied in graded or pulsed increments, and temperature margins may be defined using normalized or relative scales. The structural and operational principles described herein can likewise be applied to systems using alternative transformer types, standby power sources, or enclosure geometries.

The algorithms, methods, and processes described herein may be executed by or delivered to a controller, processor, or other computing device associated with the home energy system 10 or with one or more distributed energy resources. Such computing devices may include dedicated electronic control units, programmable electronic controllers, or general-purpose processors configured with appropriate software instructions. The disclosed logic may be stored as instructions or data in various non-transitory computer-readable media, including read-only memory, random access memory, flash devices, magnetic media, optical media, or other storage forms. Execution of such instructions may occur entirely in software, partially in software with firmware assistance, or in whole or in part using dedicated hardware such as application-specific integrated circuits, programmable logic devices, or state machines. In some implementations, control routines may be distributed across multiple hardware layers, such as a local HEMS controller 100 in communication with cloud-based servers, with processing responsibility apportioned between local and remote resources.

The embodiments described above are provided for illustration rather than limitation, and are not intended to encompass all variations falling within the scope of the appended claims. The terminology used herein is selected for purposes of clarity of description and should not be construed as restrictive. It should be understood that modifications may be made to the disclosed structures, steps, and sequences without departing from the broader concepts conveyed. For example, while particular temperature thresholds, duty cycles, or sequencing orders have been described, alternative values, gradations, or prioritization logic may be implemented depending on the context of use.

As indicated above, the features of different embodiments may be used in combination or in modified form to generate additional implementations not expressly illustrated. Although certain embodiments may be described in relation to their suitability for addressing specific operational conditions, such as cold-weather operation with heater modulation or hot-weather operation with load shedding, those skilled in the art will recognize that compromises or substitutions may be made among characteristics to achieve overall system objectives. These attributes may relate, for example, to efficiency of control, responsiveness to transients, coordination with grid conditions, computational complexity, or integration with existing infrastructure. Thus, embodiments described as less favorable with respect to one characteristic may nonetheless be advantageous in other contexts, and remain within the scope of this disclosure.

What is claimed is:

1. A home energy system comprising:
a standby battery;
a neutral-forming transformer (NFT);
an imbalance relay; and
a controller configured to operate the imbalance relay when a temperature of the standby battery is less than a temperature value such that a neutral line current associated with the NFT increases and the temperature increases and to subsequently operate the imbalance relay when the temperature is greater than another temperature value such that the neutral line current increases and the temperature stops increasing.

2. The home energy system of claim 1, wherein the controller is configured to operate the imbalance relay when the temperature is greater than the temperature value such that the neutral line current increases from zero and then returns to zero and to subsequently operate the imbalance relay when the temperature is greater than the another temperature value such that the neutral line current increases from zero and then returns to zero.

3. The home energy system of claim 1, wherein the standby battery and the NFT are housed within a shared enclosure.

4. The home energy system of claim 1, further comprising a NFT relay configured to connect the NFT to a home load during off-grid operation, wherein the NFT relay and the imbalance relay share integrated switching elements.

5. The home energy system of claim 1, further comprising a NFT relay configured to connect the NFT to a home load during off-grid operation, wherein the NFT relay and the imbalance relay comprise distinct switching elements.

6. The home energy system of claim 1, wherein the imbalance relay is coupled to a secondary winding of the NFT.

7. The home energy system of claim 1, wherein the imbalance relay comprises a controllable switch operable between conductors to establish an electrical imbalance across the NFT.

8. The home energy system of claim 7, wherein the controller transitions the controllable switch between balanced and imbalanced states according to a stored temperature control routine.

9. The home energy system of claim 1, wherein the imbalance relay comprises an integrated module including both a neutral-forming transformer relay and an imbalance switch actuated by a common control signal.

10. The home energy system of claim 1, further comprising:
a battery temperature sensor associated with the standby battery; and
a transformer temperature sensor associated with the NFT.

11. A controller for a home energy system, comprising processing hardware and memory storing instructions that, when executed, cause the controller to:
when a battery temperature of a standby battery is below a cold temperature value, operate a switch to induce an electrical imbalance across a neutral-forming transformer (NFT), the electrical imbalance generating thermal energy that warms the standby battery; and
upon a mitigation condition, adjust operation of the switch to reduce thermal energy generation.

12. The controller of claim 11, wherein the mitigation condition comprises a transformer temperature exceeding a temperature value.

13. The controller of claim 11, wherein the mitigation condition comprises an imbalance current exceeding a current value.

14. The controller of claim 11, wherein the mitigation condition comprises the battery temperature reaching a target temperature value.

15. The controller of claim 11, wherein adjusting operation of the switch comprises suspending the electrical imbalance across the NFT.

16. The controller of claim 11, wherein adjusting operation of the switch comprises reducing a duty cycle.

17. A method of operating a home energy system having a standby battery and a neutral-forming transformer (NFT), the method comprising:
when a temperature of the standby battery is below a temperature value, operating a switch to apply an electrical imbalance across the NFT such that heat generated by the electrical imbalance is transferred to the standby battery; and
adjusting the electrical imbalance based on a condition of at least one of the NFT or the standby battery.

18. The method of claim 17, wherein adjusting the electrical imbalance comprises opening the switch to terminate the electrical imbalance and suspend transformer heating.

19. The method of claim 17, wherein adjusting the electrical imbalance is based on at least one of a temperature of the NFT, a current through the NFT, or the temperature of the standby battery.
